(19) United States
(12) Patent Application Publication
(10) Pub. No.: US 2025/0110053 A1
(43) Pub. Date: Apr. 3, 2025

(54) METHOD AND APPARATUS FOR DETERMINATION OF FLUORESCENT SUBSTANCES IN AQUEOUS SOLUTIONS

(71) Applicant: MFG CHEMICAL, LLC, Chattanooga, TN (US)

(72) Inventors: Garret S. GARCIA, WOOD DALE, IL (US); Michael Lee STANDISH, Chattanooga, TN (US)

(73) Assignee: MFG CHEMICAL, LLC, Chattanooga, TN (US)

(21) Appl. No.: 18/895,744

(22) Filed: Sep. 25, 2024

Related U.S. Application Data
(60) Provisional application No. 63/541,257, filed on Sep. 28, 2023.

(51) Int. Cl. G01N 21/64

(52) U.S. Cl. CPC G01N 21/6447; G01N 2201/062

(57) ABSTRACT

A method and apparatus for detecting the presence of fluorophores in aqueous solutions, particularly for industrial water treatment systems. Fluid from an industrial stream passes through a vessel. An illumination source emits light at specific wavelengths into the fluid. When the fluid contains fluorophores such as PTSA or fluorescein, it emits fluorescence, which is detected and measured. The apparatus includes a sensor and a computer system that processes the fluorescence data, providing information on the presence and concentration of fluorophores. The system is designed to be cost-effective, allowing for easy visual detection of fluorophores without the need for expensive instrumentation. This method may monitor water treatment additives, track water flow, and optimize chemical dosing, contributing to improved efficiency and reliability in water management processes.

### CROSS-REFERENCE TO RELATED APPLICATION

This application claims the benefit of U.S. Provisional Patent Application No. 63/541,257, filed on Sep. 28, 2023, which is incorporated by reference herein in its entirety,

### FIELD

The present disclosure relates generally to the detection and analysis of fluorescent substances in aqueous systems, and more specifically to methods and apparatus for detecting the presence and concentration of fluorophores in industrial water treatment processes.

### BACKGROUND

The discussion of shortcomings and needs existing in the field prior to the present disclosure is in no way an admission that such shortcomings and needs were recognized by those skilled in the art prior to the present disclosure.

Inert fluorescent dyes such as PTSA (1,3,6,8-pyrene tetrasulfonic acid tetrasodium salt) and fluorescein (3′,6′-dihydroxyspiro[isobenzofuran-1(3H),9′-[9H]xanthen]-3-one) are commonly used as tracer compounds in water treatment applications. These compounds are typically added to water systems at part per billion concentrations as a means to calculate system water volume or, alternatively, added as a component of a formulation as a means to track dosage of chemical treatment in various types of water treatment applications. For example, fluorescent dyes may be utilized to calculate with a high degree of accuracy the system volume of a cooling system including the piping, process components, and cooling tower. Another example would be to add a fluorescent dye to a water treatment formulation containing other additives such as scale and corrosion inhibitors. When used in this manner, the inert dye can be useful in accurately determining the dosage of the water treatment formulations. Additionally, fluorescent dyes are valued for their ability to provide insights into the behavior and effectiveness of water treatment processes. Fluorescent dyes may be used to trace and visualize the flow of water within treatment systems. By introducing a small concentration of these dyes into the water, operators can track the movement and dispersion of water, helping to identify dead zones or areas with insufficient treatment. Water treatment facilities often need to identify potential contamination sources or pathways. Fluorescent dyes can be introduced at suspected points of contamination, and their movement can be tracked to determine whether contaminants are reaching the treated water supply. Proper mixing of chemicals in water treatment processes may be crucial for efficient treatment. Fluorescent dyes may be added to the chemicals to observe how well they disperse and mix within the water. This helps ensure that chemicals are evenly distributed for maximum effectiveness. Residence time is the duration that water spends in a treatment system. By introducing a fluorescent dye with a known decay rate, operators can calculate the residence time of water within various treatment components. This information aids in optimizing treatment efficiency. In distribution systems, the presence of leaks or breaches in pipes can be a significant issue. Fluorescent dyes may be used to trace the path of water in a distribution network, helping to pinpoint the exact location of leaks or contamination entry points. Sedimentation and filtration are key steps in water treatment. Fluorescent dyes may be employed to track the movement of particles and assess the effectiveness of these processes. This ensures that solid contaminants are adequately removed. In the development of new water treatment technologies, fluorescent dyes are also valuable for researchers. They provide a visual means to understand the behavior of chemicals, particles, and water in novel treatment systems, leading to advancements in water treatment science. Regulatory bodies often require water treatment facilities to demonstrate compliance with water quality standards. Fluorescent dyes may be used to validate treatment processes and ensure that treated water meets the necessary quality criteria. Fluorescent dyes like PTSA and fluorescein serve as essential tools in water treatment applications. Their ability to fluoresce under specific conditions allows water treatment professionals to gain valuable insights into processes, detect potential issues, and optimize treatment systems for safe and clean water supply to communities. These dyes contribute to the continuous improvement of water treatment technologies and the preservation of water quality.

Similarly, fluorescent compounds can be covalently bonded to water treatment additives used for mineral scale control, corrosion inhibition, microbial control, or other functional compounds whereas those specific compounds concentration and/or change in concentration can be determined and monitored. The benefit of a covalently bound fluorescent dye is it's affixed association with the active water treatment additive. For example, a fluorescent dye which is covalently bound to a mineral scale inhibitor, corrosion inhibitor or biocide will be depleted in the water system as the scale inhibitor, corrosion inhibitor, or biocide is consumed. Typically, determination of either inert fluorescent dyes or covalently bound fluorescent compounds is accomplished using expensive instrumentation since the visual determination of the presence or concentration of the fluorophore at typical use levels is not readily viewable by the naked eye. The instrumentation functions by using a light source to excite the fluorescent compound (fluorophore) at a specific wavelength such that it emits light at a separate wavelength that can be quantified based upon the emission intensity. Such equipment includes laboratory fluorometers, hand-held fluorometers, and/or in-line process probes. In many applications, the use of such instrumentation is cost prohibitive or a significant deterrent to the user or potential users of fluorescent technologies. Because of this, there is a need for a low-cost method for determining the presence of fluorophores in aqueous systems.

### SUMMARY

Various embodiments solve the above-mentioned problems and provide methods and devices useful for

One embodiment describes a method for detecting the presence of a fluorophore in an industrial stream. The method may comprise providing a vessel. The vessel may be fluidically coupled to the industrial stream to receive a fluid from the industrial stream and to return the fluid to the industrial stream. The method may further comprise providing an illumination source. The illumination source may be configured and positioned to emit light that impinges upon the fluid in central compartment of the vessel. The method may further comprise detecting a fluorescence emitted from the fluid. The fluid may have a residence time within the central compartment of from about 1 to 100 seconds. The light that impinges upon the fluid in the central compartment of the vessel may have a wavelength corresponding to the excitation wavelength of a known fluorophore. The excitation wavelength may be from 300 nm to 600 nm. The step of detecting the fluorescence may comprise detecting an emission wavelength of the fluorescence. The method may further comprise providing a determination of whether the known fluorophore is present in the fluid. The known fluorophore may be selected from PTSA, fluorescein, copolymers comprising covalently bound fluorescent monomer repeat units, and combinations thereof. The method may further comprise detecting an intensity of the fluorescence. The method may further comprise providing a determination of a concentration of the known fluorophore in the fluid. The method may further comprise providing a sensor for detecting the fluorescence. The method may further comprise providing a computer system communicatively coupled to the sensor. The computer system may be configured to provide an output in response to detecting the fluorescence via the sensor. The method may further comprise providing a housing that may enclose at least the vessel.

Another embodiment describes a method for detecting the presence of a fluorophore in a fluid that is not necessarily a component of an industrial stream. In other words, the method may be applied in other settings, such as laboratory research, environmental monitoring, or smaller-scale water systems. The method may comprise providing a vessel. The vessel may comprise the fluid to be tested. The method may further comprise providing an illumination source. The illumination source may be configured and positioned to emit light that impinges upon the fluid. The method may further comprise detecting a fluorescence emitted from the fluid. The light that impinges upon the fluid may have a wavelength corresponding to the excitation wavelength of a known fluorophore. The excitation wavelength may be from 300 nm to 600 nm. The step of detecting the fluorescence may comprise detecting an emission wavelength of the fluorescence. The method may further comprise providing a determination of whether the known fluorophore is present in the fluid. The known fluorophore may be selected from PTSA, fluorescein, copolymers comprising covalently bound fluorescent monomer repeat units, and combinations thereof. The method may further comprise detecting an intensity of the fluorescence. The method may further comprise providing a determination of a concentration of the known fluorophore in the fluid.

Another embodiment describes a method for detecting the presence of a plurality of fluorophores in a fluid. The method may comprise providing a vessel. The vessel may comprise the fluid to be tested. The method may further comprise providing an illumination source. The illumination source may be configured and positioned to emit light that impinges upon the fluid at a plurality of excitation wavelengths, including at least a first excitation wavelength and a second excitation wavelength. The method may further comprise detecting a first fluorescence emitted from the fluid in response to light at the first excitation wavelength and detecting a second fluorescence emitted from the fluid in response to light at the second excitation wavelength. The illumination source may comprise a plurality of light emitting diodes, including at least a first light emitting diode that emits light at the first excitation wavelength and a second light emitting diode that emits light at the second excitation wavelength.

Another embodiment describes a method for detecting the presence of a plurality of fluorophores in a fluid. The method may comprise illuminating the fluid at a plurality of excitation wavelengths. The plurality of excitation wavelengths may include at least a first excitation wavelength and a second excitation wavelength. The method may further comprise detecting a first fluorescence emitted from the fluid in response to light at the first excitation wavelength and detecting a second fluorescence emitted from the fluid in response to light at the second excitation wavelength.

Another embodiment describes a method for detecting the presence of a plurality of fluorophores in a fluid. The method may comprise providing a vessel. The vessel may comprise the fluid. The method may further comprise providing a first illumination source. The first illumination source may be configured and positioned to emit light that impinges upon the fluid at a first excitation wavelength. The method may further comprise providing a second illumination source. The second illumination source may be configured and positioned to emit light that impinges upon the fluid at a second excitation wavelengths. The method may further comprise detecting a first fluorescence emitted from the fluid in response to light at the first excitation wavelength and detecting a second fluorescence emitted from the fluid in response to light at the second excitation wavelength.

These and other features, aspects, and advantages of various embodiments will become better understood with reference to the following description, figures, and claims.

### BRIEF DESCRIPTION OF THE DRAWINGS

Many aspects of this disclosure can be better understood with reference to the following figures, which illustrate examples according to various embodiments.

FIG. 1 is a schematic diagram that illustrates a system according to various embodiments.

FIG. 2 is a schematic diagram that illustrates a system according to various embodiments.

FIG. 3 is a schematic diagram that illustrates a system according to various embodiments.

FIG. 4A is a block diagram that illustrates a calibration method according to various embodiments.

FIG. 4B is a block diagram that illustrates a method according to various embodiments for determining the presence of and optionally the amount of a fluorophore in a fluid.

FIG. 4C is a block diagram that illustrates a method according to various embodiments for determining the presence of and optionally the amounts of multiple fluorophores in a fluid.

FIG. 5 is a block diagram that illustrates a computer system upon which an embodiment of the invention may be implemented.

FIG. 6 is a block diagram that illustrates a chip set upon which an embodiment of the invention may be implemented.

FIG. 7 is a photograph showing a prototype of a system according to various embodiments comprising a blank sample with 0 mg/l of copolymer present, according to Example 1.

FIG. 8 is a photograph showing a prototype of a system according to various embodiments comprising a sample with 10 mg/l of copolymer present, according to Example 2.

FIG. 9 is a photograph showing a prototype of a system according to various embodiments comprising a sample with 20 mg/l of copolymer present, according to Example 3.

FIG. 10 is a photograph showing a light array used in the a prototype of a system according to various embodiments and as tested in Examples 1-3.

FIG. 11 is a chart showing an exemplary emission and excitation spectrum for Fluorescein.

It should be understood that the various embodiments are not limited to the examples illustrated in the figures.

### DETAILED DESCRIPTION

### Introduction and Definitions

This disclosure is written to describe the invention to a person having ordinary skill in the art, who will understand that this disclosure is not limited to the specific examples or embodiments described. The examples and embodiments are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

In this specification and in the claims that follow, reference will be made to a number of terms that shall be defined to have the following meanings unless a contrary intention is apparent.

“Standard temperature and pressure” generally refers to 25° C. and 1 atmosphere. Standard temperature and pressure may also be referred to as “ambient conditions.” The terms “elevated temperatures” or “high-temperatures” generally refer to temperatures of at least about 25° C. The terms “elevated pressures” or “high-pressures” generally refer to pressures of greater than 1 atmosphere. Most industrial water applications will operate at elevated temperature and/or pressures. For example, a cooling tower may operate at temperatures at about 70° C. to 90° C. at atmospheric pressure. On the other hand, an industrial boiler may operate at temperatures of about 100 to about 284° C. and a pressures of about 1 atmosphere to about 70 atmospheres. Both applications may employ water comprising fluorescent dyes or polymers comprising covalently bonded fluorescent tags.

In the context of fluorescence and the use of inert fluorescent dyes or covalently bonded fluorescent tags in polymers and copolymers, the terms “excitation spectrum,” “excitation wavelength,” “emission spectrum,” and “emission wavelength” have specific meanings.

“Excitation spectrum” refers to a graphical representation or a set of data points depicting the fluorophore's absorption characteristics across a range of different wavelengths or energies. It illustrates variations in the efficiency with which the fluorophore absorbs incident light at different wavelengths. The excitation spectrum may be helpful in determining the optimal wavelengths for exciting the fluorophore, thereby influencing its subsequent fluorescence emission. It typically provides data on the relationship between the intensity of absorbed light and the corresponding wavelength, enabling fine-tuning of excitation sources for applications such as fluorescence-based microscopy, spectroscopy, and assays.

“Excitation wavelength” denotes a specific wavelength of incident light within the excitation spectrum that exhibits the highest efficacy in exciting the fluorophore. It is essentially the peak wavelength within the excitation spectrum, representing the point at which the fluorophore demonstrates its strongest light absorption characteristics.

“Emission spectrum” refers to a graphical depiction or a dataset illustrating the fluorophore's fluorescence emission characteristics over a range of distinct wavelengths or energies. It provides insights into how efficiently the fluorophore emits light at various wavelengths following excitation. The emission spectrum may aid in identifying the optimal wavelengths for detecting and capturing the emitted fluorescence signal.

“Emission wavelength” “refers to a specific wavelength of emitted light produced by the fluorophore subsequent to excitation. This wavelength corresponds to the peak emission within the emission spectrum, signifying the wavelength at which the fluorophore emits light most intensely. This emission wavelength may serve as a reference point for configuring detection and measurement systems according to various embodiments and for ensuring the accurate capture and analysis of the emitted fluorescence signal.

“Transparent” refers to a property of a material that encompasses the idea that a material may permit the passage of certain wavelengths of light or electromagnetic radiation while blocking or absorbing others. It indicates that the material's behavior regarding the transmission of light or radiation may vary depending on the specific wavelengths involved. A material may be transparent to some wavelengths but not others and may allow certain portions of the electromagnetic spectrum to pass through with minimal absorption or scattering, while simultaneously obstructing or attenuating other wavelengths. This selective transmission or absorption of different wavelengths can occur due to the material's molecular structure, composition, or specific properties, resulting in varying degrees of transparency across the electromagnetic spectrum.

Inert Fluorescent dyes and fluorescent tagging compounds covalently bonded to other treatment compounds may exhibit a unique property where they absorb photons of a particular wavelength of incident light and then re-emit photons at longer wavelengths, which may be perceive as fluorescence. The specific wavelengths at which different fluorescent dyes fluoresce, known as their excitation and emission wavelengths, vary depending on the chemical structure of the dye molecule. Some common fluorescent dyes and their excitation and emission wavelengths are detailed, however, it is to be appreciated that the system and method according to various embodiments may be utilized with any type of fluorescent dyes as well as with any fluorescent tagging compound covalently bonded to other treatment compounds.

Fluorescein (3′,6′-dihydroxyspiro[isobenzofuran-1(3H),9′-[9H]xanthen]-3-one) is one of the most well-known and widely used fluorescent dyes. Fluorescein is based on the xanthene tricyclic structural motif, formally belonging to triarylmethine dyes family. Triarylmethane dyes are synthetic organic compounds containing triphenylmethane backbones. Fluorescein emits bright green fluorescence when excited by blue or green light. Fluorescein has a structure according to Formula 1.

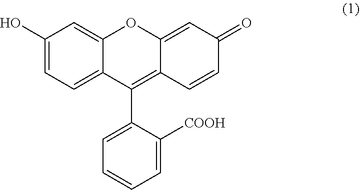 [SMILES: O=C(O)c1ccccc1-c1c2ccc(=O)cc-2oc2cc(O)ccc12]

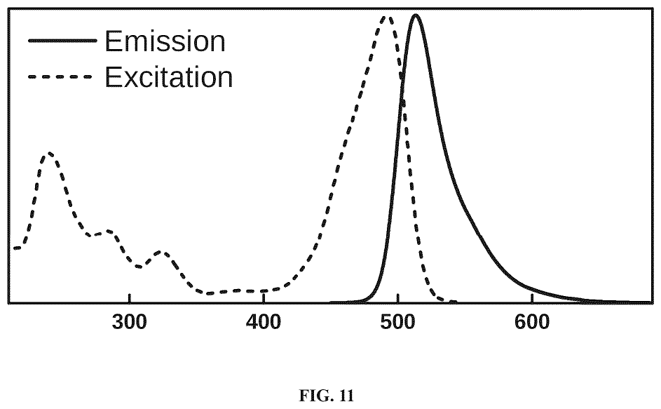

Fluorescein has excitation wavelength of about 495 nm and an emission wavelength of about 515 to about 520 nm. An exemplary emission and excitation spectrum for Fluorescein is shown in FIG. 11.

Fluorescein isothiocyanate (FITC) is a derivative of fluorescein. It is commonly employed in immunofluorescence and flow cytometry assays. It has an excitation wavelength at approximately 490 nm to about 495 nm and an emission wavelength of about 515 nm to about 520 nm. Fluorescein isothiocyanate has isometric structures (Fluorescein 5-isothiocyanate and Fluorescein 6-isothiocyanate) according to Formulas 2a and 2b.

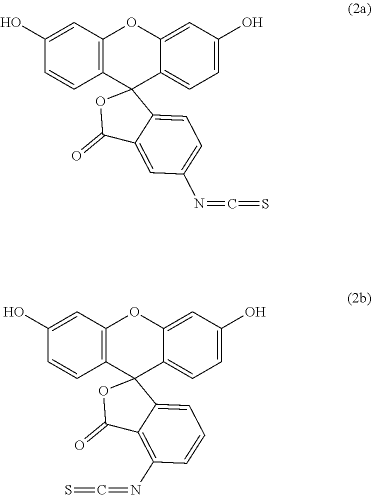 [SMILES: O=C1OC2(c3ccc(O)cc3Oc3cc(O)ccc32)c2ccc(N=C=S)cc21 ; O=C1OC2(c3ccc(O)cc3Oc3cc(O)ccc32)c2cccc(N=C=S)c21]

PTSA (1,3,6,8-pyrene tetrasulfonic acid tetrasodium salt) has an excitation wavelength at approximately 360 nm to about 370 nm. Its emission spectrum covers a broad range from about 370 nm to about 600 nm, with different emission peaks at various wavelengths within that range. Polymers incorporating covalently linked naphthalamide monomers may emit fluorescence with distinctive characteristics, featuring an excitation wavelength extending from about 400 to about 430 nm and an emission wavelength from about 440 to about 470 nm.

Triazoles, such as tolyltriazole and benzotriazole, may be used as corrosion inhibitors in water treatment and also fluoresce with an emission wavelength at about 590 to about 600 nm. Some triazole compounds may have excitation wavelengths in the UV range, typically from about 300 nm to about 400 nm. Others may have excitation wavelengths in the visible range, such as from about 400 nm to about 700 nm.

Tolyltriazole typically displays an excitation wavelength range of about 330 nm to about 340 nm, making it sensitive to ultraviolet (UV) light sources. Upon excitation within this range, tolyltriazole emits fluorescence that spans across a wide spectrum, ranging from about 340 nm to about 500 nm, with distinct emission peaks occurring at various wavelengths within this interval. This extensive emission profile renders tolyltriazole a versatile candidate for applications in fluorescence-based research, corrosion inhibition studies, and the development of environmentally friendly inhibitors for various industrial processes.

Benzotriazole exhibits an excitation wavelength ranging from about 300 nm to about 310 nm, making it responsive to ultraviolet (UV) radiation. Upon excitation within this UV range, benzotriazole emits fluorescence, covering a wide spectral window from about 310 nm to about 430 nm, characterized by distinct emission peaks at various wavelengths within this spectrum. This broad emission profile makes benzotriazole a valuable candidate for a range of applications, including corrosion inhibition studies, UV protection in polymers and coatings, and analytical techniques requiring fluorescent labeling and detection.

The excitation and emission wavelengths and resulting intensities for inert fluorescent dyes and covalently bound fluorescent dyes such as polymers and copolymers tagged with fluorescent moieties can vary widely depending on the specific fluorescent dye or moiety used, its chemical structure, and shifts due to the covalent incorporation or manner of incorporation of the moiety into the active additive compound. Tagged polymers or copolymers may have any structure and may include but are not limited to random copolymers, alternating copolymers, block copolymers, graft copolymers, periodic copolymers, statistical copolymers, gradient copolymers, multiblock copolymers, star copolymers, deblock copolymers, and triblock copolymers. The polymers may comprise any combination of vinyl monomers. According to various embodiments, the copolymers may comprise one or more multifunctional monomers such as methylenebisacrylamide, diallyl phthalate, divinyl benzene, tetra allyl ammonium chloride, to facilitate branching, structuring, or crosslinking. According to various embodiments, the copolymers may also comprise one or more covalent tag detectable fluorescent monomers, including but not limited to:
1H-Benz[de]isoquinoline-2(3H)-propanaminium, N-[2-hydroxy-3-(2-propen-1-yloxy) propyl]-6-methoxy-N,N-dimethyl-1,3-dioxo-, hydroxide;
1H-Benz[de]isoquinoline-2(3H)-propanaminium, N-[2-hydroxy-3-(2-propen-1-yloxy) propyl]-N,N-dimethyl-1,3-dioxo-, hydroxide; or
1H-Benz[de]isoquinoline-2(3H)-propanaminium, 6-methoxy-N, N-dimethyl-1,3-dioxo-N-2-propen-1-yl-, chloride.

Such tagged polymers may have an excitation wavelength of about 400 to about 420 nm and an emission wavelength of about 440 to about 460 nm.

In general, the present invention addresses the issue of significant costs associated with measurement of fluorophores in aqueous solutions by providing a simple and low-cost visual approach for the user. The invention involves the use of a transparent, flow through or stagnant cell device that is illuminated with a common light source capable of producing light between 10 and 700 nm. Such apparatus produces a low-cost visual determination of the presence of fluorophores in aqueous solutions. The invention can be further refined to use image analysis software for further quantification of the fluorophore and/or specific light source wavelengths to selectively illuminate specific fluorophores such as PTSA only, fluorescein only, or covalently bound napthalamide monomers only. An example of the invention is demonstrated in the attached photographs where a progression of covalently bound napthalamide monomer is copolymerized into a copolymer containing comonomers of acrylic acid and 2-acrylamido 2-methylpropane sulfonic acid.

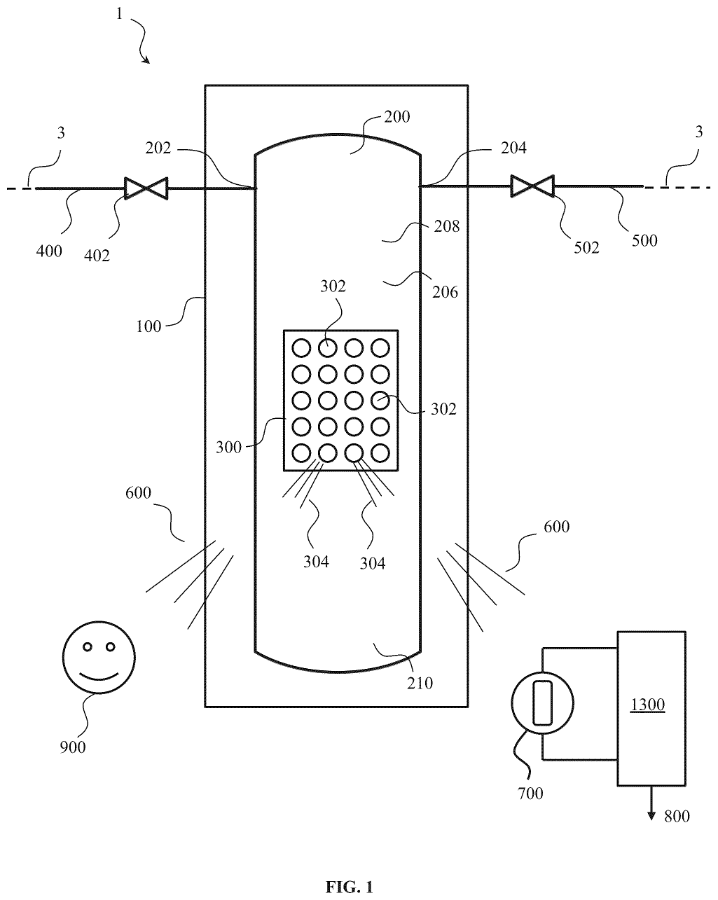

FIG. 1 is a schematic diagram that illustrates a system 1 according to various embodiments that may be incorporated into an industrial stream 3. The system 1 may comprise a vessel 200 having at least one transparent portion 210. As will be discussed hereinafter, the transparent portion 210 may be transparent with respect to a fluorescence 600 at an emission wavelength and/or to light 304 at an excitation wavelength.

The vessel 200 may optionally be enclosed within a housing 100. The vessel 200 may comprise an inlet 202 and an outlet 204, configured to allow a fluid 206 to pass into and out of a central compartment 208. For example, a fluid 206 may flow through an inlet stream 400, through the inlet 202, into the central compartment 208 of the vessel 200, until the central compartment 208 is filled sufficiently to allow the fluid to flow through the outlet 204 to an outlet stream 500. The inlet stream 400 may have an inlet valve 402 to regulate or to cut-off flow therethrough. Similarly, the outlet stream 500 may have an outlet valve 502 to regulate or to cut-off flow therethrough.

The system 1 may further comprise one or more illumination sources 300, which may be disposed either within the central compartment 208 or outside the vessel 200. The illumination source 300 may comprise one or more lights 302, such as for example a plurality of LED lights. The one or more illumination sources 300 and/or the one or more lights 302 may simultaneously or independently emit light 304. The light 304 may be emitted at one or more excitation wavelengths. For example, the one or more illumination sources 300 and/or the one or more lights 302 may emit light 304 at a first excitation wavelength and simultaneously or subsequently emit light 304 at a second excitation wavelength. The first excitation wavelength and the second excitation wavelength may be the same or different. The excitation wavelength(s) may correspond to an excitation wavelength for one or more particular fluorophores. For example, for a fluorophore that is known to be or that may be contained within the fluid 206. For example, the illumination source 300 may be disposed within the housing 100 in a position behind the vessel 200 to allow light from the illumination source 300 to illuminate the fluid 206. If the fluid 206 comprises a fluorophore and if the illumination source 300 provides light 304 having a wavelength corresponding to the fluorophore's excitation wavelength, then after being illuminated, the fluid 206 may emit a fluorescence 600 at the fluorophore's emission wavelength. This fluorescence 600 may be observed by a human observer 900 and/or may be detected by one or more sensors 700, which may provide one or more signals to a computer system 1300. The computer system 1300 may comprise software for translating the signal from the one or more sensors 700 into an output 800. The software may comprise or employ artificial intelligence. The software may facilitate or conduct visual comparisons and/or calibrations, enabling a determination of a specific concentration of a fluorophore in a fluid. The output 800 may comprise an indication of the emission wavelength, an indication of the intensity of the fluorescence 600, and/or an indication of a likely fluorophore responsible for the fluorescence.

Although the system 1 shown in FIG. 1 is a flow-through embodiment, in which fluid 206 flows through the vessel 200, it is to be appreciated that static devices and sample cells may also be employed. In such embodiments, the fluid 206 may simply reside within a vessel 200 and be illuminated with an illumination source 300. The flow the fluid 206 is very convenient in many applications where determining the presence, type, and amount of a fluorophore is needed, but the flow of the fluid 206 is not required in to produce fluorescence.

The illumination source 300 may be selected to provide light 304 having a wavelength in a range of from about 490 to about 500 nm to illuminate and to prompt fluorescence in Fluorescein. Additionally or alternatively, the illumination source 300 may be selected to provide light 304 having a wavelength in a range of from about 360 to about 370 nm to illuminate and to prompt fluorescence in PTSA (1,3,6,8-pyrene tetrasulfonic acid tetrasodium salt). Additionally or alternatively, the illumination source 300 may be selected to provide light 304 having a wavelength in a range of from about 400 to about 430 nm to illuminate and to prompt fluorescence in copolymers with covalently linked napthalamide monomer. Additionally or alternatively, the illumination source 300 may be selected to provide light 304 having a wavelength in a range of from about 330 nm to about 340 nm to illuminate and to prompt fluorescence in tolyltriazole. Additionally or alternatively, the illumination source 300 may be selected to provide light 304 having a wavelength in a range of from about 300 nm to about 310 nm to illuminate and to prompt fluorescence in benzotriazole.

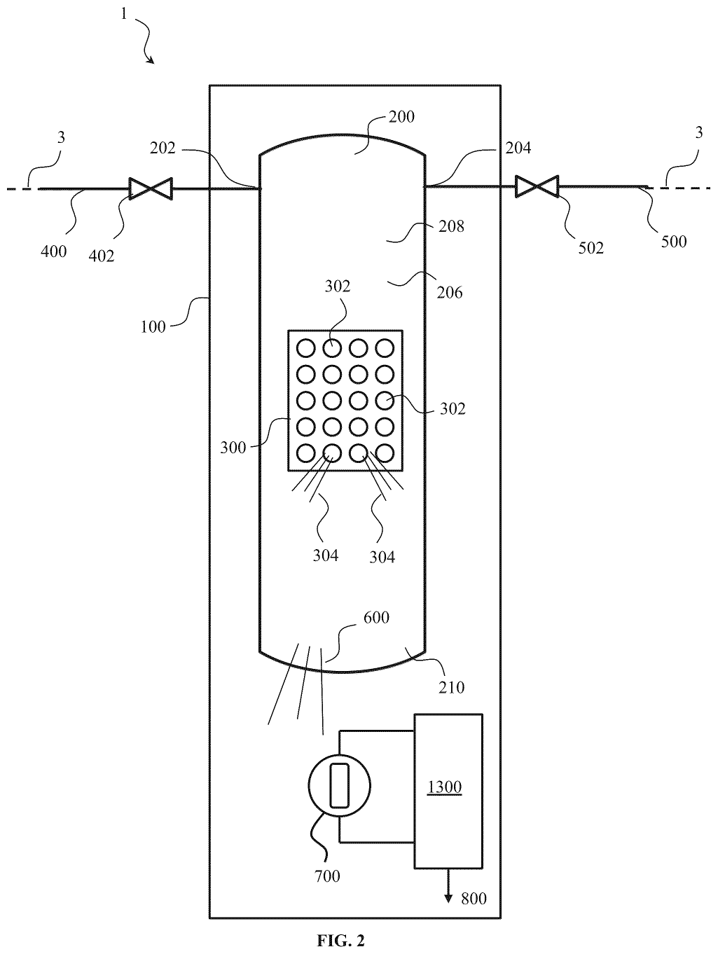

FIG. 2 is a variation on the system 1 shown in FIG. 1 in which the computer system 1300 and the one or more sensors are disposed within the housing 100.

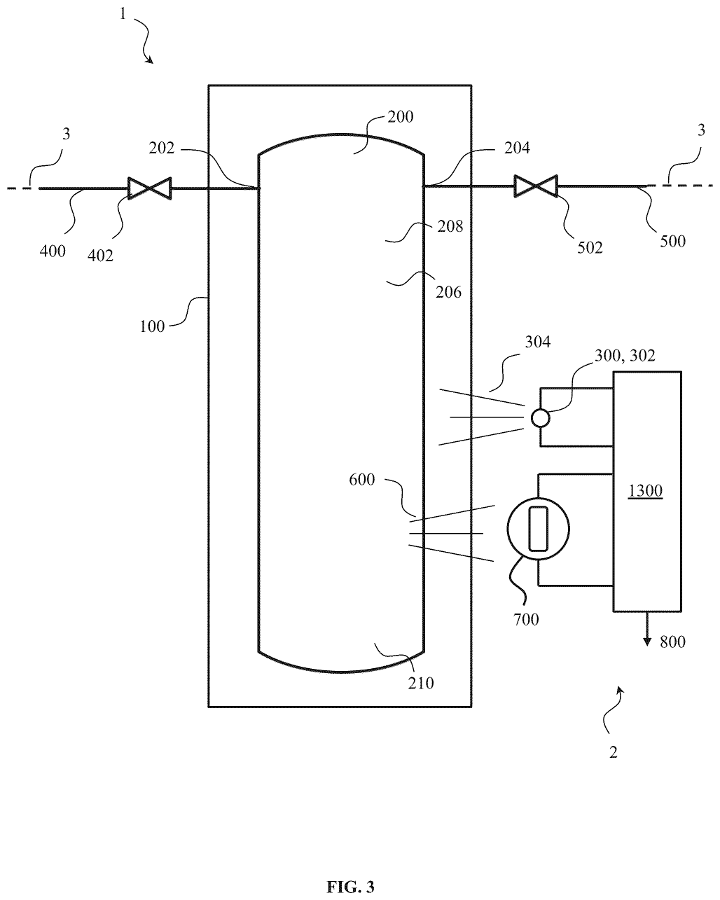

FIG. 3 is a variation on the system 1 shown in FIG. 1 in which the computer system 1300, the one or more sensors, and the illumination source 300 are disposed outside the housing 100. For example, the computer system 1300, the one or more sensors, and the illumination source 300, may be components of a separate device 2. The separate device 2 may be a mobile device, such as a smart phone, in which case the illumination source 300 may be a camera flash or a display and the sensor may be one or more front or rear cameras. Such a smart phone may comprise software application, an “app,” to perform the computations described herein.

It is to be appreciated that although only a single illumination source 300 and a single sensor 700 may be illustrated in some figures, multiple illumination sources 300 and multiple sensors 700 may be employed in any embodiment described herein. The multiple illumination sources 300 and multiple sensors 700 may be housed in the same or in different devices.

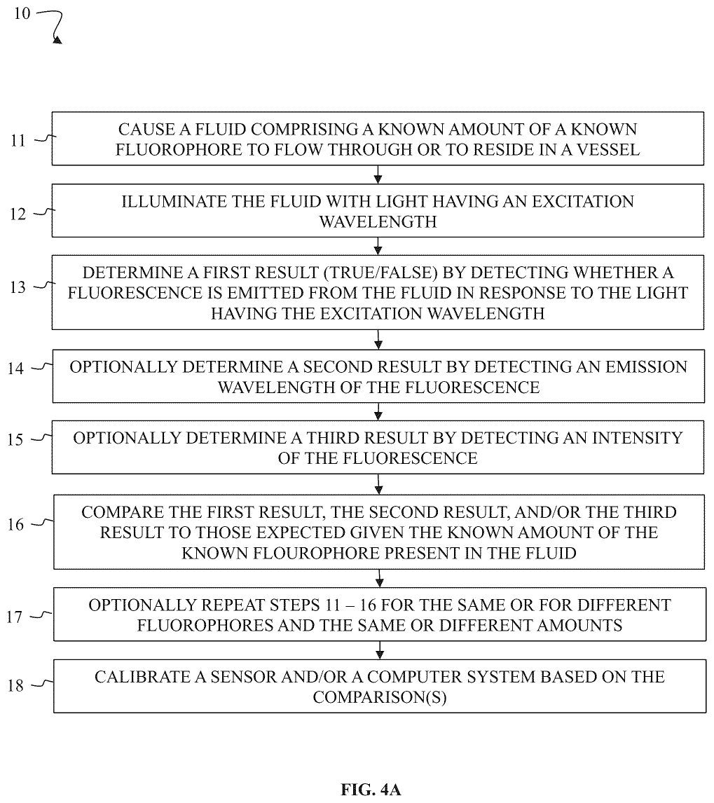

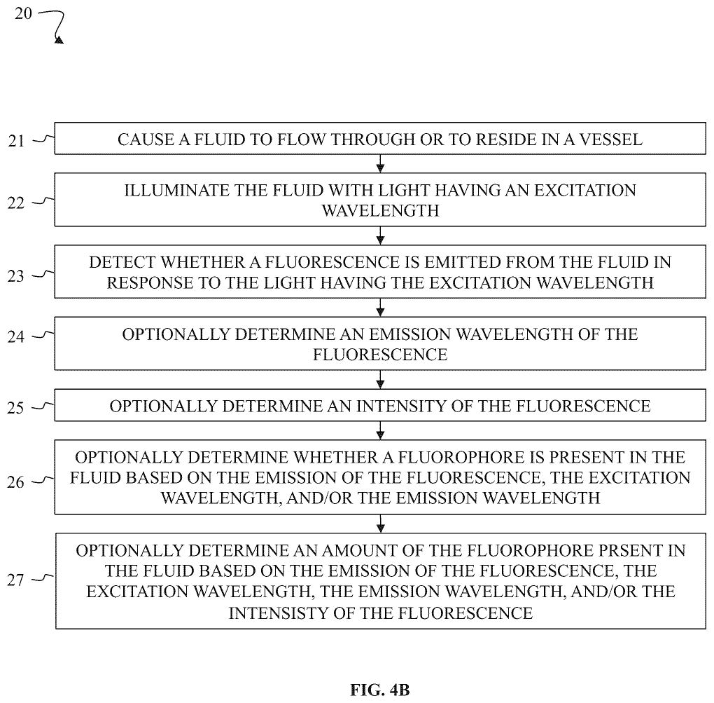

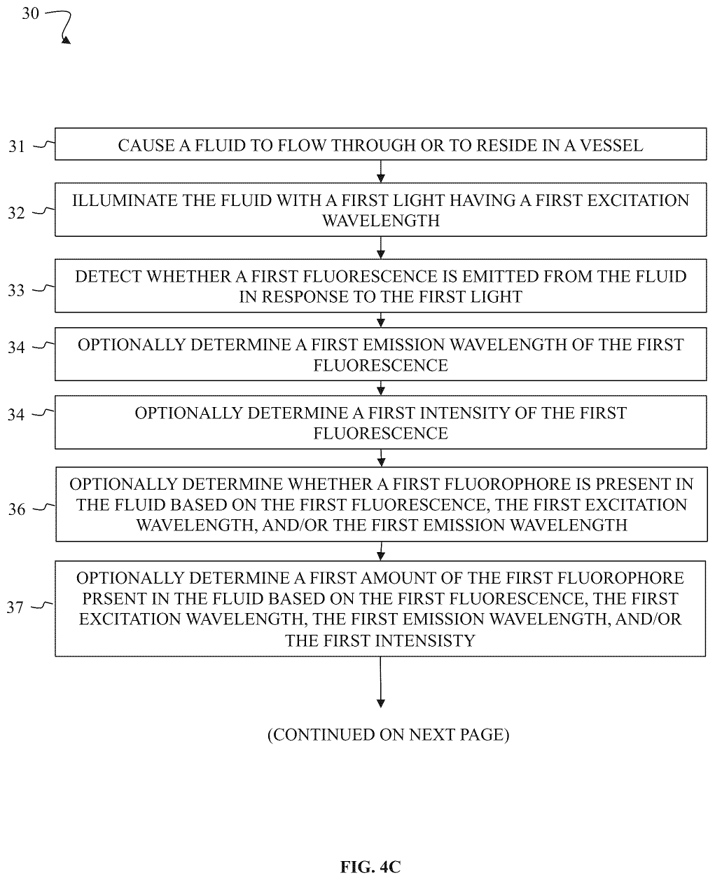

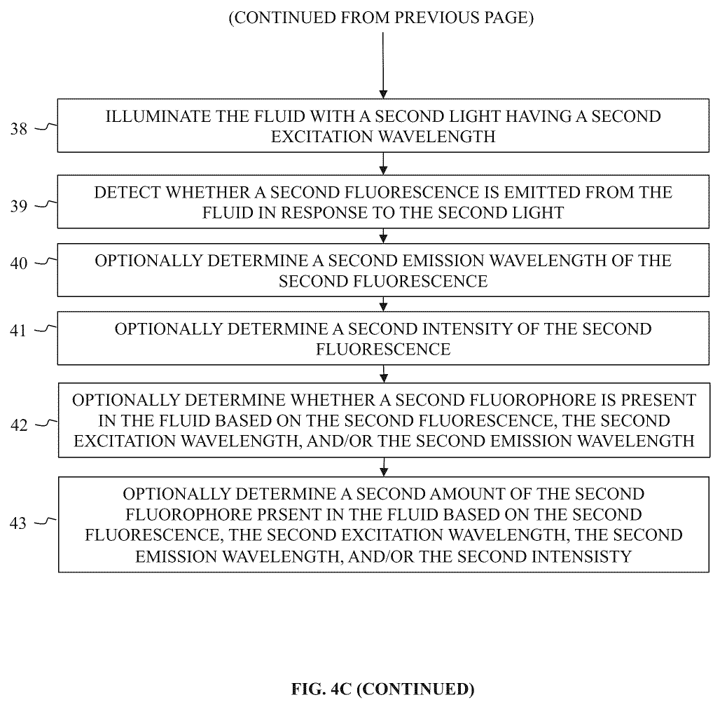

FIG. 4A is a block diagram that illustrates a calibration method 10 according to various embodiments. The calibration method 10 may comprise a step 11 of causing a fluid comprising a known amount of a known fluorophore to flow through or to reside in a vessel. The vessel may be a vessel 200 comprising at least one transparent portion 210 (transparent at the relevant wavelengths) as illustrated in FIGS. 1-3. The calibration method 10 may comprise a second step 12 of illuminating the fluid with light having an excitation wavelength. The excitation wavelength may be determined to correspond or not to correspond with a known excitation wavelength of the known fluorophore in the fluid. Next, the calibration method 10 may comprise a step 13 of determining a first result by detecting whether a fluorescence is emitted from the fluid in response to the light having the excitation wavelength. The first result may simply be an indication of whether the fluorescence is detected or not, for example a yes/no or true/false type indication. Next, the calibration method 10 may comprise an optional step 14 of determining a second result by detecting an emission wavelength of the fluorescence. The second result may be a value quantifying the emission wavelength in units such as, for example, nanometers. Next, the calibration method 10 may comprise an optional step 15 of determining a third result by detecting an intensity of the fluorescence. The third result may be a value quantifying the intensity of the fluorescence in units such as, for example, fluorescence intensity units (FIU) or photon flux (photons per second) or radiant power (watts). Next, the calibration method 10 may comprise a step 16 of comparing the first result, the second result, and/or the third result to the results that would be expected given the known amount of the known fluorophore that is present in the fluid. Next, the calibration method 10 may comprise an optional step 17 of repeating any or all of steps 11 to 16 for the same or for different fluorophores at the same or different amounts/concentrations. Next, the calibration method 10 may comprise a step 18 of calibrating a sensor, such as sensor 700, or a computer system, such as computer system 1300, based on the comparison in step 16 or based on a set of comparisons from repeated iterations of step 16. For example, a known fluorophore may have a known excitation wavelength. An expected intensity of fluorescence and an expected emission wavelength may be determined for that fluorophore when it is provided in a known amount and is exposed to light having a known wavelength for a known time period. The intensity of fluorescence and the observed emission wavelength detected by a sensor may be compared to the expected values and a setting of the sensor may be adjusted or otherwise compensated for.

FIG. 4B is a block diagram that illustrates a method 20 according to various embodiments for determining the presence of and optionally the amount of a fluorophore in a fluid. The method 20 may comprise a step 21 of causing a fluid to flow through or to reside in a vessel. The method 20 may comprise a step 22 of illuminating the fluid with light having an excitation wavelength. The method 20 may comprise a step 23 of detecting whether a fluorescence is emitted from the fluid in response to the light having the excitation wavelength. The method 20 may comprise an optional step 24 of optionally determining an emission wavelength of the fluorescence. The method 20 may comprise an optional step 25 of optionally determining an intensity of the fluorescence. The method 20 may comprise an optional step 26 of optionally determining whether a fluorophore is present in the fluid based on the emission of the fluorescence, the excitation wavelength, and/or the emission wavelength. The method 20 may comprise an optional step 27 of optionally determining an amount of the fluorophore present in the fluid based on the emission of the fluorescence, the excitation wavelength, the emission wavelength, and/or the intensity of the fluorescence.

FIG. 4C is a block diagram that illustrates a method 30 according to various embodiments for determining the presence of and optionally the amounts of multiple fluorophores in a fluid. The method 30 may comprise a step 31 of causing a fluid to flow through or to reside in a vessel. The method 30 may comprise a step 32 of illuminating the fluid with a first light having a first excitation wavelength. The method 30 may comprise a step 33 of detecting whether a first fluorescence is emitted from the fluid in response to the first light. The method 30 may comprise an optional step 34 of optionally determining a first emission wavelength of the first fluorescence. The method 30 may comprise an optional step 35 of optionally determining a first intensity of the first fluorescence. The method 30 may comprise an optional step 36 of optionally determining whether a first fluorophore is present in the fluid based on the first fluorescence, the first excitation wavelength, and/or the first emission wavelength. The method 30 may comprise an optional step 37 of optionally determining a first amount of the first fluorophore present in the fluid based on the first fluorescence, the first excitation wavelength, the first emission wavelength, and/or the first intensity. The method 30 may comprise a step 38 of illuminating the fluid with a second light having a second excitation wavelength. The method 30 may comprise a step 39 of detecting whether a second fluorescence is emitted from the fluid in response to the second light. The method 30 may comprise an optional step 40 of optionally determining a second emission wavelength of the second fluorescence. The method 30 may comprise an optional step 41 of optionally determining a second intensity of the second fluorescence. The method 30 may comprise an optional step 42 of optionally determining whether a second fluorophore is present in the fluid based on the second fluorescence, the second excitation wavelength, and/or the second emission wavelength. The method 30 may comprise an optional step 43 of optionally determining a second amount of the second fluorophore present in the fluid based on the second fluorescence, the second excitation wavelength, the second emission wavelength, and/or the second intensity.

It is to be appreciated that the presence and/or the amount of any number of fluorophores may be detected via a repetition of steps as is apparent by comparing FIG. 4B and FIG. 4C. It is also to be appreciated that the methods according to various embodiments may be performed with any of the apparatuses according to various embodiments.

### Computational Hardware Overview

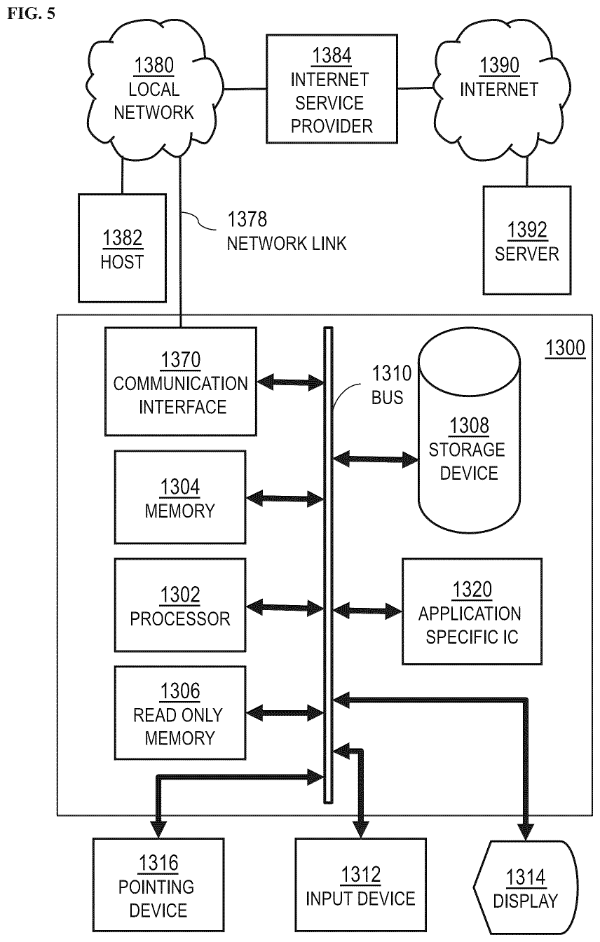

FIG. 5 is a block diagram that illustrates a computer system 1300 upon which an embodiment of the invention may be implemented. Computer system 1300 includes a communication mechanism such as a bus 1310 for passing information between other internal and external components of the computer system 1300. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit).). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1300, or a portion thereof, constitutes a means for performing one or more steps of one or more methods described herein.

A sequence of binary digits constitutes digital data that is used to represent a number or code for a character. A bus 1310 includes many parallel conductors of information so that information is transferred quickly among devices coupled to the bus 1310. One or more processors 1302 for processing information are coupled with the bus 1310. A processor 1302 performs a set of operations on information. The set of operations include bringing information in from the bus 1310 and placing information on the bus 1310. The set of operations also typically include comparing two or more units of information, shifting positions of units of information, and combining two or more units of information, such as by addition or multiplication. A sequence of operations to be executed by the processor 1302 constitutes computer instructions.

Computer system 1300 also includes a memory 1304 coupled to bus 1310. The memory 1304, such as a random access memory (RAM) or other dynamic storage device, stores information including computer instructions. Dynamic memory allows information stored therein to be changed by the computer system 1300. RAM allows a unit of information stored at a location called a memory address to be stored and retrieved independently of information at neighboring addresses. The memory 1304 is also used by the processor 1302 to store temporary values during execution of computer instructions. The computer system 1300 also includes a read only memory (ROM) 1306 or other static storage device coupled to the bus 1310 for storing static information, including instructions, that is not changed by the computer system 1300. Also coupled to bus 1310 is a non-volatile (persistent) storage device 1308, such as a magnetic disk or optical disk, for storing information, including instructions, that persists even when the computer system 1300 is turned off or otherwise loses power.

Information, including instructions, is provided to the bus 1310 for use by the processor from an external input device 1312, such as a keyboard containing alphanumeric keys operated by a human user, or a sensor, such as sensor 700 shown in FIG. 1. A sensor detects conditions in its vicinity and transforms those detections into signals compatible with the signals used to represent information in computer system 1300. Other external devices coupled to bus 1310, used primarily for interacting with humans, include a display device 1314, such as a cathode ray tube (CRT) or a liquid crystal display (LCD), for presenting images, and a pointing device 1316, such as a mouse or a trackball or cursor direction keys, for controlling a position of a small cursor image presented on the display 1314 and issuing commands associated with graphical elements presented on the display 1314. The output 800 (See: FIG. 1) may, for example be displayed on the display 1314.

In the illustrated embodiment, special purpose hardware, such as an application specific integrated circuit (IC) 1320, is coupled to bus 1310. The special purpose hardware is configured to perform operations not performed by processor 1302 quickly enough for special purposes. Examples of application specific ICs include graphics accelerator cards for generating images for display 1314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1300 also includes one or more instances of a communications interface 1370 coupled to bus 1310. Communication interface 1370 provides a two-way communication coupling to a variety of external devices that operate with their own processors, such as printers, scanners and external disks. In general the coupling is with a network link 1378 that is connected to a local network 1380 to which a variety of external devices with their own processors are connected. For example, communication interface 1370 may be a parallel port or a serial port or a universal serial bus (USB) port on a personal computer. In some embodiments, communications interface 1370 is an integrated services digital network (ISDN) card or a digital subscriber line (DSL) card or a telephone modem that provides an information communication connection to a corresponding type of telephone line. In some embodiments, a communication interface 1370 is a cable modem that converts signals on bus 1310 into signals for a communication connection over a coaxial cable or into optical signals for a communication connection over a fiber optic cable. As another example, communications interface 1370 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 1370 sends and receives electrical, acoustic or electromagnetic signals, including infrared and optical signals, that carry information streams, such as digital data. The output 800 (See: FIG. 1) may, for example be communicated via the network link 1378. To a local network 1380, thus enabling remote monitoring of the state of the system 1.

The term computer-readable medium is used herein to refer to any medium that participates in providing information to processor 1302, including instructions for execution. Such a medium may take many forms, including, but not limited to, non-volatile media, volatile media and transmission media. Non-volatile media include, for example, optical or magnetic disks, such as storage device 1308. Volatile media include, for example, dynamic memory 1304. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 1302, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 1302, except for carrier waves and other signals.

Logic encoded in one or more tangible media includes one or both of processor instructions on a computer-readable storage media and special purpose hardware, such as ASIC 1320.

Network link 1378 typically provides information communication through one or more networks to other devices that use or process the information. For example, network link 1378 may provide a connection through local network 1380 to a host computer 1382 or to equipment 1384 operated by an Internet Service Provider (ISP). ISP equipment 1384 in turn provides data communication services through the public, world-wide packet-switching communication network of networks now commonly referred to as the Internet 1390. A computer called a server 1392 connected to the Internet provides a service in response to information received over the Internet. For example, server 1392 provides information representing video data for presentation at display 1314.

The invention is related to the use of computer system 1300 for implementing the techniques described herein. According to one embodiment of the invention, those techniques are performed by computer system 1300 in response to processor 1302 executing one or more sequences of one or more instructions contained in memory 1304. Such instructions, also called software and program code, may be read into memory 1304 from another computer-readable medium such as storage device 1308. Execution of the sequences of instructions contained in memory 1304 causes processor 1302 to perform the method steps described herein. In alternative embodiments, hardware, such as application specific integrated circuit 1320, may be used in place of or in combination with software to implement the invention. Thus, embodiments of the invention are not limited to any specific combination of hardware and software.

The signals transmitted over network link 1378 and other networks through communications interface 1370, carry information to and from computer system 1300. Computer system 1300 can send and receive information, including program code, through the networks 1380, 1390 among others, through network link 1378 and communications interface 1370. In an example using the Internet 1390, a server 1392 transmits program code for a particular application, requested by a message sent from computer 1300, through Internet 1390, ISP equipment 1384, local network 1380 and communications interface 1370. The received code may be executed by processor 1302 as it is received or may be stored in storage device 1308 or other non-volatile storage for later execution, or both. In this manner, computer system 1300 may obtain application program code in the form of a signal on a carrier wave.

Various forms of computer readable media may be involved in carrying one or more sequence of instructions or data or both to processor 1302 for execution. For example, instructions and data may initially be carried on a magnetic disk of a remote computer such as host 1382. The remote computer loads the instructions and data into its dynamic memory and sends the instructions and data over a telephone line using a modem. A modem local to the computer system 1300 receives the instructions and data on a telephone line and uses an infra-red transmitter to convert the instructions and data to a signal on an infra-red a carrier wave serving as the network link 1378. An infrared detector serving as communications interface 1370 receives the instructions and data carried in the infrared signal and places information representing the instructions and data onto bus 1310. Bus 1310 carries the information to memory 1304 from which processor 1302 retrieves and executes the instructions using some of the data sent with the instructions. The instructions and data received in memory 1304 may optionally be stored on storage device 1308, either before or after execution by the processor 1302.

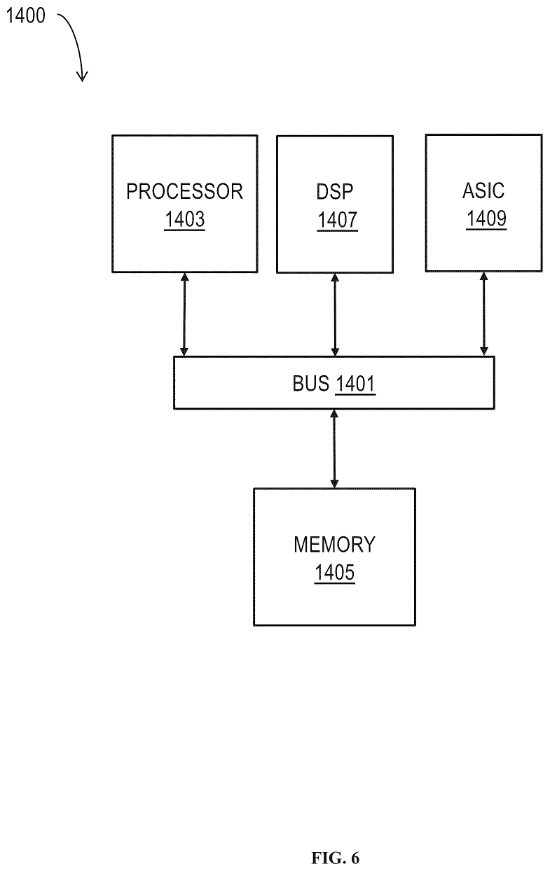

FIG. 6 illustrates a chip set 1400 upon which an embodiment of the invention may be implemented. Chip set 1400 is programmed to perform one or more steps of a method described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1400, or a portion thereof, constitutes a means for performing one or more steps of a method described herein.

In one embodiment, the chip set 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 1405 also stores the data associated with or generated by the execution of one or more steps of the methods described herein.

### EXAMPLES

The following examples are put forth to provide those of ordinary skill in the art with a complete disclosure and description of how to perform the methods, how to make, and how to use the compositions and compounds disclosed and claimed herein. Efforts have been made to ensure accuracy with respect to numbers (e.g., amounts, temperature, etc.), but some errors and deviations should be accounted for. The purpose of the following examples is not to limit the scope of the various embodiments, but merely to provide examples illustrating specific embodiments.

### Example 1

A purpose of this example is to demonstrate a blank sample with 0 mg/l of copolymer present. The particular polymer utilized was a copolymer containing comonomers of acrylic acid, 2-acrylamido 2-methylpropane sulfonic acid and a covalently bound napthalamide monomer.

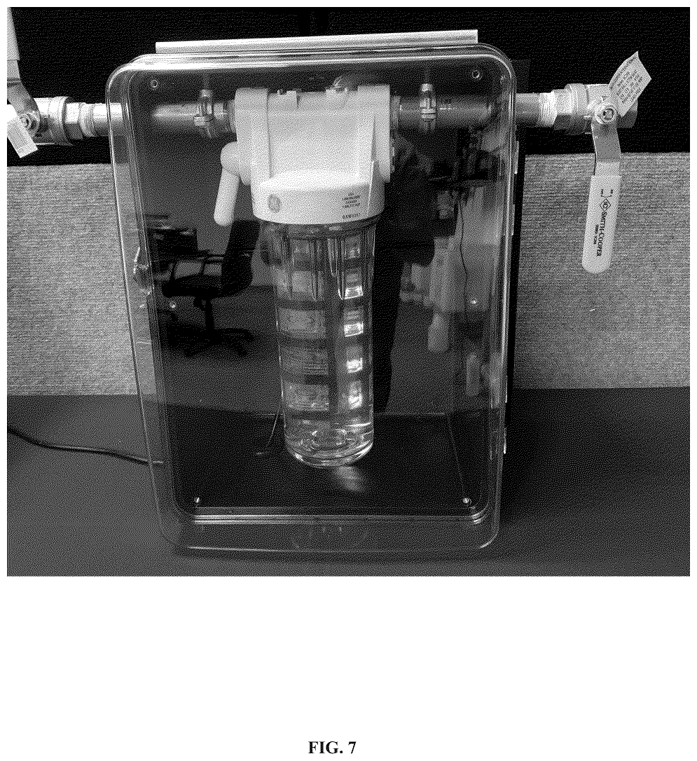

The sample was illuminated with light having a wavelength of 395-400 nm. The results of this example are shown in FIG. 7. As can be seen in FIG. 7, no visual illumination fluorescent moieties were observed in the blank sample with 0 mg/l of copolymer present.

### Example 2

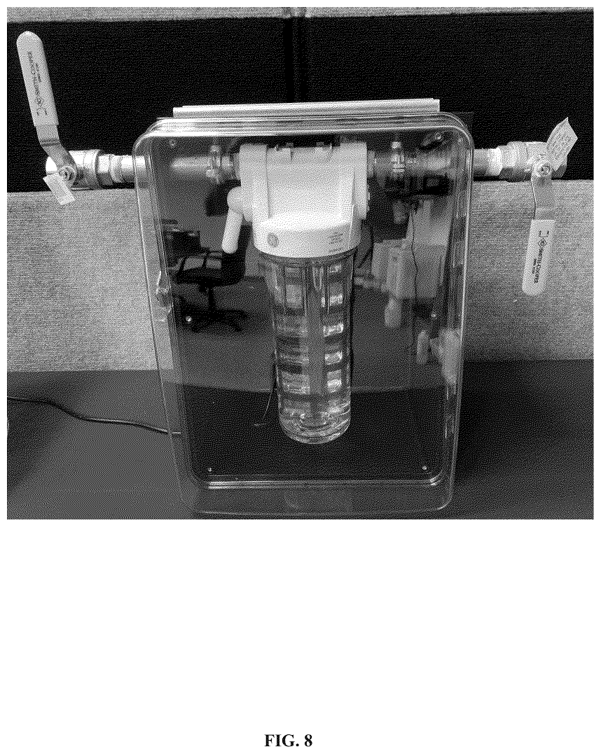

A purpose of this example is to demonstrate a sample with 10 mg/l of copolymer present. The particular polymer utilized was a copolymer containing comonomers of acrylic acid, 2-acrylamido 2-methylpropane sulfonic acid and a covalently bound napthalamide monomer. The sample was illuminated with light having a wavelength of 395-400 nm. The results of this example are shown in FIG. 8. As can be seen in FIG. 8, a characteristic violet to blue emission of light is visually observed within the wavelengths of 440 nm-470 nm.

### Example 3

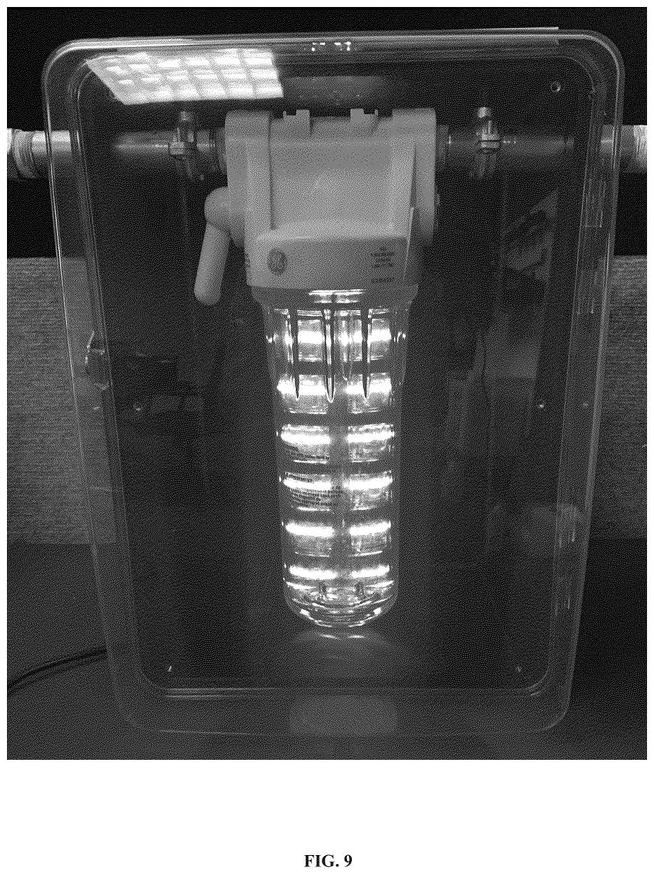

A purpose of this example is to demonstrate a sample with 20 mg/l of copolymer present in a prototype of a flow-through device. The particular polymer utilized was a copolymer containing comonomers of acrylic acid, 2-acrylamido 2-methylpropane sulfonic acid and a covalently bound napthalamide monomer. The sample was illuminated with light having a wavelength of 395-400 nm. The results of this example are shown in FIG. 9. As can be seen in FIG. 9, an intense characteristic violet to blue emission of light is visually observed within the wavelengths of 440 nm-470 nm.

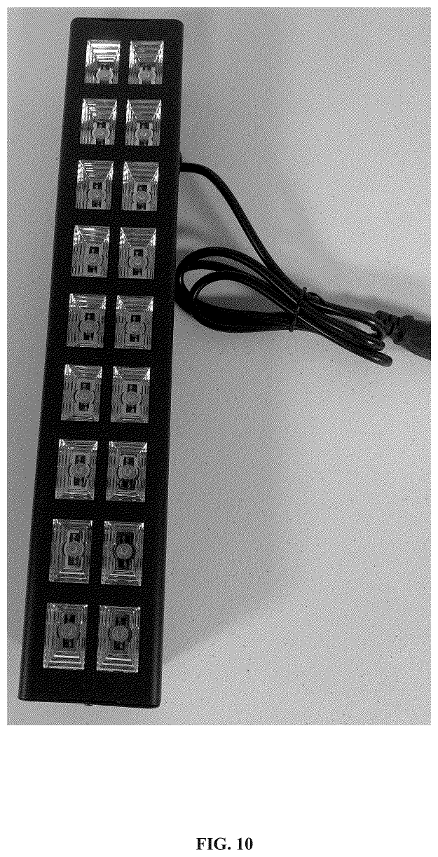

FIG. 10 is a photograph showing the light array used in the prototype of a system according to various embodiments and as tested in Examples 1-3. The light array was manufactured by Gohyo. The light array was a UV LED black light. The light array had a voltage of AC90-240V 50-60 HZ. The LED Light Sources were 18×3 W 395-400 nm UV LEDs. The beam angle was 120 degrees.

### Further Definitions and Cross-References

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for detecting the presence of a fluorophore in an industrial stream, the method comprising:
providing a vessel, the vessel being fluidically coupled to the industrial stream to receive a fluid from the industrial stream and to return the fluid to the industrial stream;
providing an illumination source, the illumination source being configured and positioned to emit light that impinges upon the fluid in central compartment of the vessel; and
detecting a fluorescence emitted from the fluid.

2. The method according to claim 1, wherein the fluid has a residence time within the central compartment of from about 1 to 100 seconds.

3. The method according to claim 1, wherein the light that impinges upon the fluid in the central compartment of the vessel has a wavelength corresponding to the excitation wavelength of a known fluorophore.

4. The method according to claim 3, wherein the excitation wavelength is from 300 nm to 600 nm.

5. The method according to claim 3, wherein detecting the fluorescence comprises detecting an emission wavelength of the fluorescence.

6. The method according to claim 5, further comprising providing a determination of whether the known fluorophore is present in the fluid.

7. The method according to claim 6, wherein the known fluorophore is selected from PTSA, fluorescein, copolymers comprising covalently bound fluorescent monomer repeat units, and combinations thereof.

8. The method according to claim 6, further comprising detecting an intensity of the fluorescence.

9. The method according to claim 8, further comprising providing a determination of a concentration of the known fluorophore in the fluid.

10. The method according to claim 1, further comprising providing a sensor for detecting the fluorescence.

11. The method according to claim 10, further comprising providing a computer system communicatively coupled to the sensor, the computer system being configured to provide an output in response to detecting the fluorescence via the sensor.

12. The method according to claim 1, further comprising providing a housing, the housing enclosing at least the vessel.

13. A method for detecting the presence of a fluorophore in a fluid, the method comprising:
providing a vessel, the vessel comprising the fluid;
providing an illumination source, the illumination source being configured and positioned to emit light that impinges upon the fluid; and
detecting a fluorescence emitted from the fluid.

14. The method according to claim 1, wherein the light that impinges upon the fluid has a wavelength corresponding to the excitation wavelength of a known fluorophore.

15. The method according to claim 14, wherein the excitation wavelength is from 300 nm to 600 nm.

16. The method according to claim 14, wherein detecting the fluorescence comprises detecting an emission wavelength of the fluorescence.

17. The method according to claim 16, further comprising providing a determination of whether the known fluorophore is present in the fluid.

18. The method according to claim 17, wherein the known fluorophore is selected from PTSA, fluorescein, copolymers comprising covalently bound fluorescent monomer repeat units, and combinations thereof.

19. The method according to claim 17, further comprising detecting an intensity of the fluorescence.

20. The method according to claim 19, further comprising providing a determination of a concentration of the known fluorophore in the fluid.

21. A method for detecting the presence of a plurality of fluorophores in a fluid, the method comprising:
providing a vessel, the vessel comprising the fluid;
providing an illumination source, the illumination source being configured and positioned to emit light that impinges upon the fluid at a plurality of excitation wavelengths, including at least a first excitation wavelength and a second excitation wavelength;
detecting a first fluorescence emitted from the fluid in response to light at the first excitation wavelength; and
detecting a second fluorescence emitted from the fluid in response to light at the second excitation wavelength.

22. The method according to claim 21, wherein the illumination source comprises a plurality of light emitting diodes, including at least a first light emitting diode that emits light at the first excitation wavelength and a second light emitting diode that emits light at the second excitation wavelength.

23. A method for detecting the presence of a plurality of fluorophores in a fluid, the method comprising:
illuminating the fluid at a plurality of excitation wavelengths, including at least a first excitation wavelength and a second excitation wavelength;
detecting a first fluorescence emitted from the fluid in response to light at the first excitation wavelength; and
detecting a second fluorescence emitted from the fluid in response to light at the second excitation wavelength.

24. A method for detecting the presence of a plurality of fluorophores in a fluid, the method comprising:
providing a vessel, the vessel comprising the fluid;
providing a first illumination source, the first illumination source being configured and positioned to emit light that impinges upon the fluid at a first excitation wavelength;
providing a second illumination source, the second illumination source being configured and positioned to emit light that impinges upon the fluid at a second excitation wavelength;
detecting a first fluorescence emitted from the fluid in response to light at the first excitation wavelength; and
detecting a second fluorescence emitted from the fluid in response to light at the second excitation wavelength.
